(19) United States
(12) Patent Application Publication
(10) Pub. No.: US 2014/0289620 A1
(43) Pub. Date: Sep. 25, 2014

(54) METHOD AND DEVICE FOR TRIGGERING OPERATIONS VIA INTERFACE COMPONENTS

(71) Applicant: TENCENT TECHNOLOGY (SHENZHEN) COMPANY LIMITED, Shenzhen (CN)

(72) Inventors: Zhao Liang XIE, Shenzhen (CN); Wen Liang TANG, Shenzhen (CN); Xing ZENG, Shenzhen (CN); Rui Tian CAI, Shenzhen (CN)

(73) Assignee: TENCENT TECHNOLOGY (SHENZHEN) COMPANY LIMITED, Shenzhen (CN)

(21) Appl. No.: 14/279,164

(22) Filed: May 15, 2014

Related U.S. Application Data
(63) Continuation of application No. PCT/CN2013/083434, filed on Sep. 13, 2013.

(30) Foreign Application Priority Data
Sep. 14, 2012 (CN) 2012103417718

(51) Int. Cl. G06F 3/0481; G06F 3/01; G06F 3/0484

(52) U.S. Cl. CPC G06F 3/04817; G06F 3/04845; G06F 3/016
USPC 715/702; 715/799

(57) ABSTRACT

The present disclosure discloses method and device for triggering operations via interface components. The method comprises: triggering movement of a floating window corresponding to an interface component by operating on the floating window; moving the floating window to a first region; triggering a release command to release the floating window in the first region; running the interface component corresponding to the floating window in accordance with the release command. The device comprises: a triggering module that triggers movement of a floating window corresponding to an interface component by operating on the floating window; a movement module that moves the floating window to a first region; a release module that triggers a release command to release the floating window in the first region; and a running module that runs the interface component corresponding to the floating window in accordance with the release command. The present disclosure greatly enhances operational convenience.

### CROSS REFERENCE TO RELATED APPLICATION

This application is a U.S. national application under 35 U.S.C. §111(a) claiming priority, under 35 U.S.C. §120, to International Application No. PCT/CN2013/083434 filed on Sep. 13, 2013, which claims the priority benefit of Chinese Patent Application No. 201210341771.8, filed Sep. 14, 2012, the contents of both the PCT application and the Chinese application are incorporated by reference herein in their entirety for all purposes.

### TECHNICAL FIELD

The present disclosure relates generally to the technological field of human-computer interactions, and more particularly, to a method and device for triggering operations via interface components.

### BACKGROUND

Different interface components are often set on a graphical interface that interacts with users for the ease of the users to trigger various types of shortcut operations, and for enhancing the operational convenience of the graphical interface. For example, a desktop interface can have an interface component for release of memory. When the interface component on the desktop interface is activated and a component interface corresponding to the interface component is displayed, the release of memory can be triggered by obtaining an operation in the component interface.

However, traditional processes of triggering the running of an interface component require users to open and display a component interface corresponding to the interface component via an interface opening operation. The running of the interface component is triggered only when an operation is entered in the component interface. Such process of triggering the running of an interface component requires relatively complicated operations and lacks convenience.

### SUMMARY OF THE DISCLOSURE

One of the technical problems to be solved by embodiments of the present disclosure is the relative complexity of triggering the operation of interface components. To solve these technical problems, the present disclosure provides an interface component launching method that increases the convenience. In addition, the present disclosure also provides an interface component launching device.

An interface component launching method comprises:

Triggering movement of a floating window corresponding to an interface component by operating on the floating window;

Moving the floating window to a first region;

Triggering a release command to release the floating window in the first region; and

Running the interface component corresponding to the floating window in accordance with the release command.

An interface component launching device comprises:

A triggering module that triggers movement of a floating window corresponding to an interface component by operating on the floating window;

A moving module that moves the floating window to a first region;

A release module that triggers a release command to release the floating window in the first region; and

A running module that runs the interface component corresponding to the floating window in accordance with the release command.

According to the above-described interface component launching method and device, in a process of triggering movement of an interface component icon by an operation on a floating window, generation of a release command to release the floating window can be triggered when the floating window moves to a first region, enabling the interface component to run via the release command. In this process, a user can accomplish the running of an interface component by merely two consecutive operations, namely, triggering the movement of the floating window and triggering the release of the floating window. No complicated operation is necessary. This greatly enhances the convenience and interactivity.

### BRIEF DESCRIPTION OF THE DRAWINGS

FIG. 1 is a schematic diagram illustrating an example of the flow of an interface component launching method according to various embodiments.

FIG. 2 is a schematic diagram illustrating an example of a desktop interface showing the dragging of a floating window in the form of a rocket according to various embodiments.

FIG. 3 is a schematic diagram illustrating an example of a desktop interface showing the dragging of a floating window in the form of a rocket to a first region in the desktop interface according to various embodiments.

FIG. 4 is a schematic diagram illustrating an example of a desktop interface showing an animation of the launch of a floating window in the form of a rocket according to various embodiments.

FIG. 5 is a schematic diagram illustrating an example of a desktop interface showing a result of the running of an interface component according to various embodiments.

FIG. 6 is a schematic diagram illustrating an example of a desktop interface showing the clicking of a floating window in the form of a rocket according to various embodiments.

FIG. 7 is a schematic diagram illustrating an example of a desktop interface showing an open interface after clicking a floating window.

FIG. 8 is a schematic diagram illustrating an example of an arrangement of an interface component launching device according to various embodiments.

FIG. 9 is a schematic diagram illustrating an example of an arrangement of an interface component launching device according to various embodiments.

FIG. 10 is a schematic diagram illustrating an example of an arrangement of an interface component launching device according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

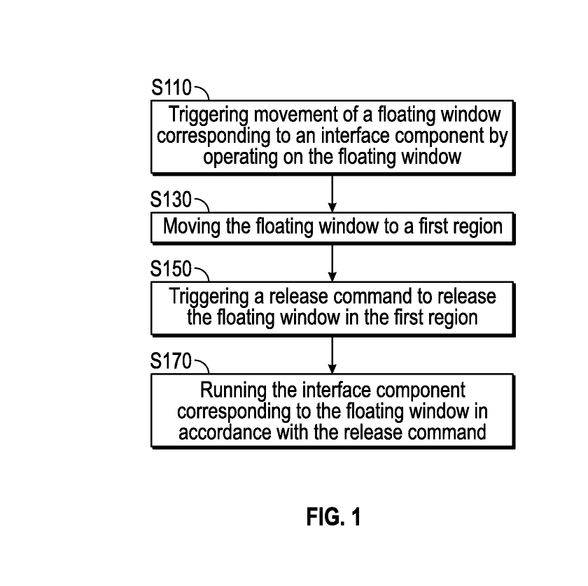

FIG. 1 is a schematic diagram illustrating an example of the flow of an interface component launching method according to various embodiments. As used herein, launching an interface component means triggering the running of the interface component. The method can comprise:

Step S110: triggering movement of a floating window corresponding to an interface component by operating on the floating window.

According to some embodiments, an interface component can be an application program, a functional module of an application program or a plugin in an application program. As used herein, a floating window refers to a window that displays the current status of an interface component. It is considered part of the interface component, and is placed in a graphical interface for users to view anytime. According to some embodiments, a graphical interface can be a desktop interface.

According to some embodiments, a dragging command can be generated by obtaining a dragging operation entered on a floating window corresponding to an interface component. The floating window can be converted to a first form and moved in accordance with the dragging command. According to these embodiments, the dragging operation works on the floating window. According to some embodiments, the first form comprises a preset form. Through a dragging operation on a floating window, a user can trigger a continuous movement of the floating window in a graphical interface following the user's dragging operation, and convert the floating window into a first form during the movement. Examples of a first form of a floating window include, but are not limited to, a form of a rocket.

According to some embodiments, after Step S110, the method can comprise a step of providing a label to a first region in accordance with the movement of the floating window. According to some embodiments, the first region comprises a preset region.

According to these embodiments, a first region can be configured in a graphical interface. When a floating window moves, the first region configured in the graphical interface can be marked and a label can be provided to the first region. According to some embodiments, a process of providing a label to a first region can be providing a color label to the first region. According to some other embodiments, a process of providing a label to a first region can be highlighting the first region. According to yet some other embodiments, a process of providing a label to a first region can be providing a prompt message such as “drag the floating window here” in the first region. Methods of providing a label to a first region are well known to those skilled in the art.

Step S130: moving the floating window to a first region.

According to some embodiments, a floating window can be moved to a first region by operating on the floating window. According to some embodiments, a release message can also be fed back to the floating window that has moved to the first region. The message can prompt a user to convert a drag operation into a release operation, thereby releasing the floating window.

According to some embodiments, a process of feeding back a release message to a floating window that has moved to a first region can comprise: checking the first region to determine whether the floating window is located in the first region. If yes, then the release message can be generated and fed back; if not, then no action is taken.

According to some embodiments, a release message can be presented in the form of changing the color of the first region. According to some other embodiments, a release message can be presented by generating a vibration. According to yet some other embodiments, a release message can be presented by displaying such texts as “Please release” around the interface component icon. Methods of presenting a release message are well known to those skilled in the art.

In the embodiments where a release message is presented by generating a vibration, a process of feeding back the release message to a floating window that has moved to a first region can comprise: generating a vibration command in accordance with the floating window that has moved to the first region, enabling a terminal device on which the interface component is installed to vibrate in accordance with the vibration command. According to these embodiments, a vibration command can be generated when a floating window moves to a first region, and a vibration of a terminal device on which the interface component is installed can be generated via the vibration command. According to some embodiments, a terminal device on which an interface component is installed can be a mobile terminal device. Examples of mobile terminal devices include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, or any other mobile Internet device (“MID”) or intelligent communication terminal, all of which are well known to those skilled in the art. According to some other embodiments, a terminal device on which an interface component is installed can be a non-mobile terminal. As used herein, a non-mobile terminal device refers to a terminal device not susceptible to frequent moves (although it is not impossible to move the device), e.g., a desktop PC or a smart TV.

By generating a vibration of the terminal device via a vibration command when a floating window of an interface component enters a first region on the terminal device, the process of running the interface component can be visually fed back to a user. This brings the interface component and the user closer and enhances the interface component's ease of use.

Step S150: triggering a release command to release the floating window in the first region.

According to some embodiments, a user's release operation on a floating window that has moved to a first region can be detected, and a corresponding release command can be generated in accordance with the release operation on the floating window.

According to some embodiments, after a release command is triggered, the floating window can be released via the release command, and an animation showing the releasing of the floating window can be played. According to some embodiments, when a user triggers an operation to release a floating window, an animation showing a sudden release of the floating window following the user's release operation can be played, thereby vividly reflecting the running of the interface component. By way of example only, if the floating window is in the form of a rocket, the floating window in the form of a rocket can move after a dragging operation entered by a user. When the user triggers a release operation, the floating window in the form of a rocket can be released, i.e., an animation showing the launch and acceleration of the floating window in the form of a rocket can be played in a graphical interface.

Step S170: running the interface component corresponding to the floating window in accordance with the release command.

According to some embodiments, after obtaining the command to release a floating window, the interface component corresponding to the floating window can be run. According to some embodiments, the interface component can be an application program that releases the memory. According to these embodiments, running the interface component corresponding to the floating window in accordance with the release command can comprise: triggering the running of the interface component in accordance with the release command, and releasing the memory via the running interface component. According to some specific embodiments, an application program that releases the memory can be run when a command to release a floating window is triggered. The application program can inspect programs that are running in the operating system and close some unnecessary programs to release the memory and to accelerate the running of the operating system.

According to some embodiments, after running the interface component corresponding to the floating window in accordance with the release command, the method can comprise: obtaining and displaying a result of the running of the interface component when the running of the interface component is complete.

According to some embodiments, a result of the running of an interface component can be obtained and displayed in a graphical interface. According to the embodiments where the interface component is an application program that releases the memory, a result of the running of the interface component after the running is complete can be the size of the memory released.

According to some embodiments, the interface component launching method can also comprise: obtaining a clicking operation on the floating window, generating an interface opening command in accordance with the clicking operation, and opening a graphical interface of the interface component corresponding to the floating window via the interface opening command. According to these embodiments, a user can open a graphical interface corresponding to an interface component by a clicking operation on the floating window of the interface component. This one-click operation greatly simplifies user operations.

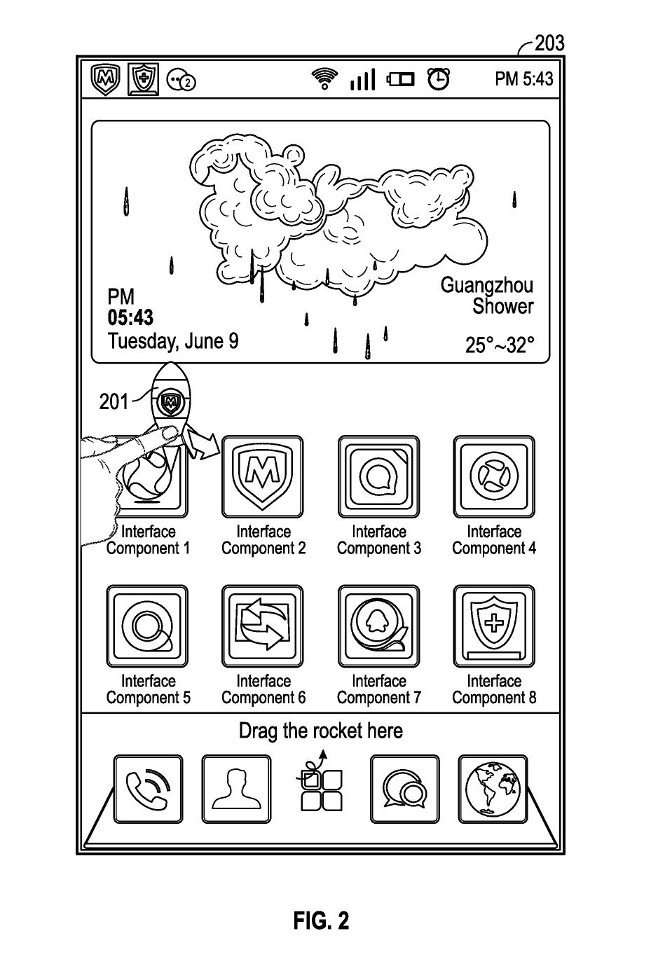

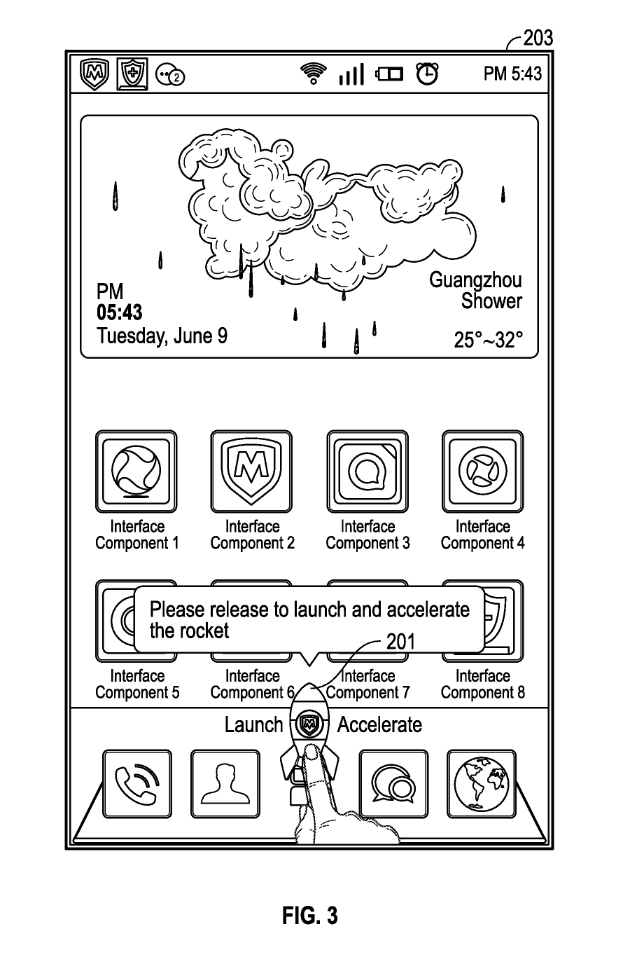

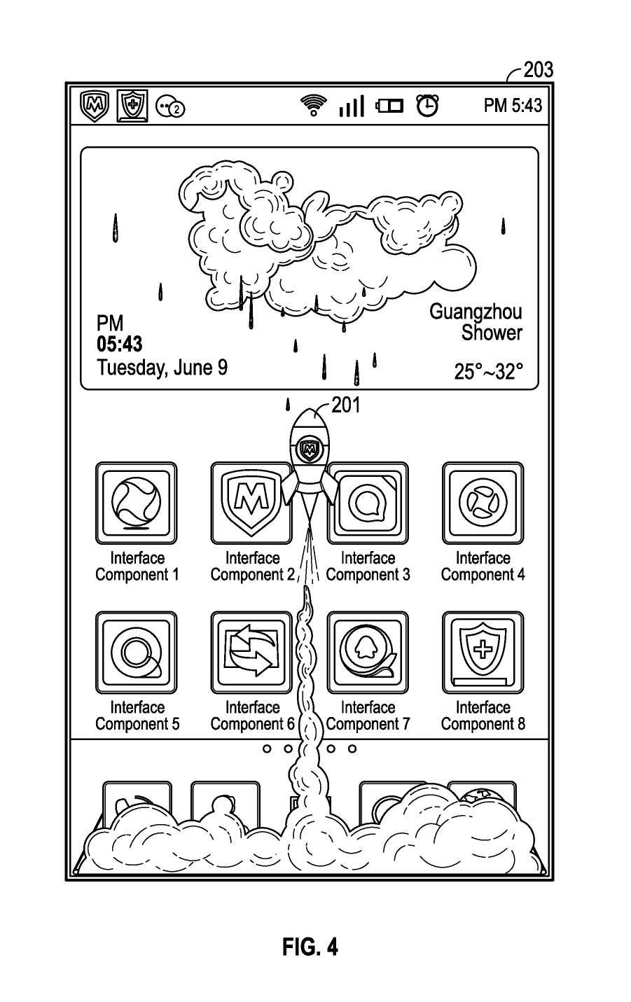

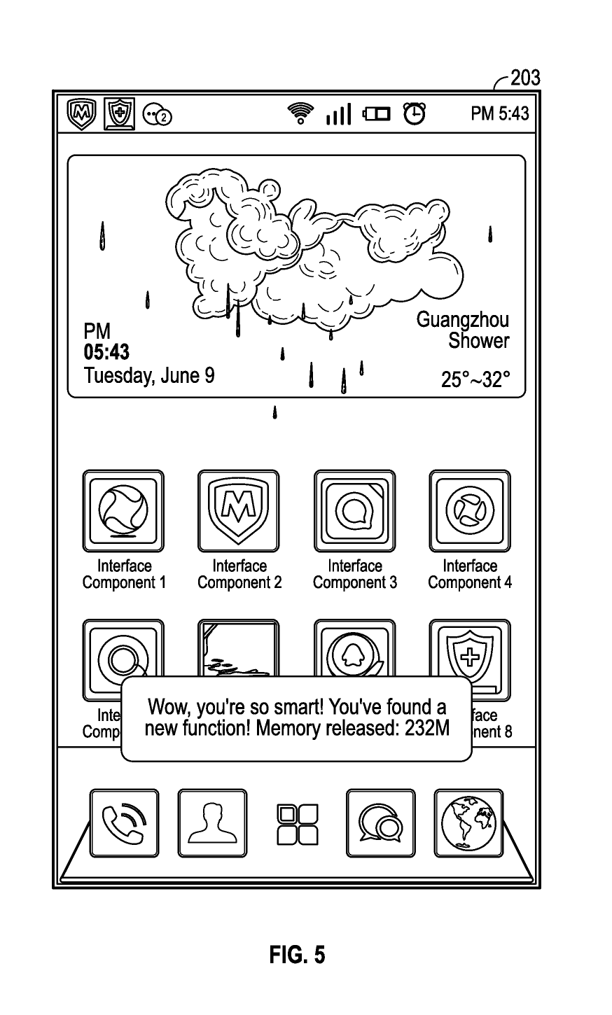

The interface component launching method is described with reference to a specific embodiment below. According to this embodiment, the interface component is an application program that releases memory space, a floating window is converted into a form of a rocket 201 (hereinafter the “rocket-form floating window”) when a movement of the floating window across a desktop interface 203 is triggered, and the desktop interface 203 also comprises a first region, which is a preset region. As illustrated in FIG. 2, a dragging operation entered by a user can be obtained in the desktop interface 203 to enable the rocket-form floating window 201 to move following the user's dragging operation. As illustrated in FIG. 3, when the rocket-form floating window 201 moves to the first region, a release message “Please release; the rocket will be launched and accelerated” can be fed back. The user can release the rocket-form floating window 201 dragged to the first region when she sees the release message, after which an animation of the rocket-form floating window 201 being launched can be played, as illustrated in FIG. 4. In addition, memory space can be released when the dragged rocket-form floating window 201 is released, and the result of memory space release can be obtained after the play of the animation of the rocket-form floating window 201 being launched is complete, and displayed in the desktop interface 203. As illustrated in FIG. 5, the user can know that 232M of memory has been released when viewing the result displayed in the desktop interface 203.

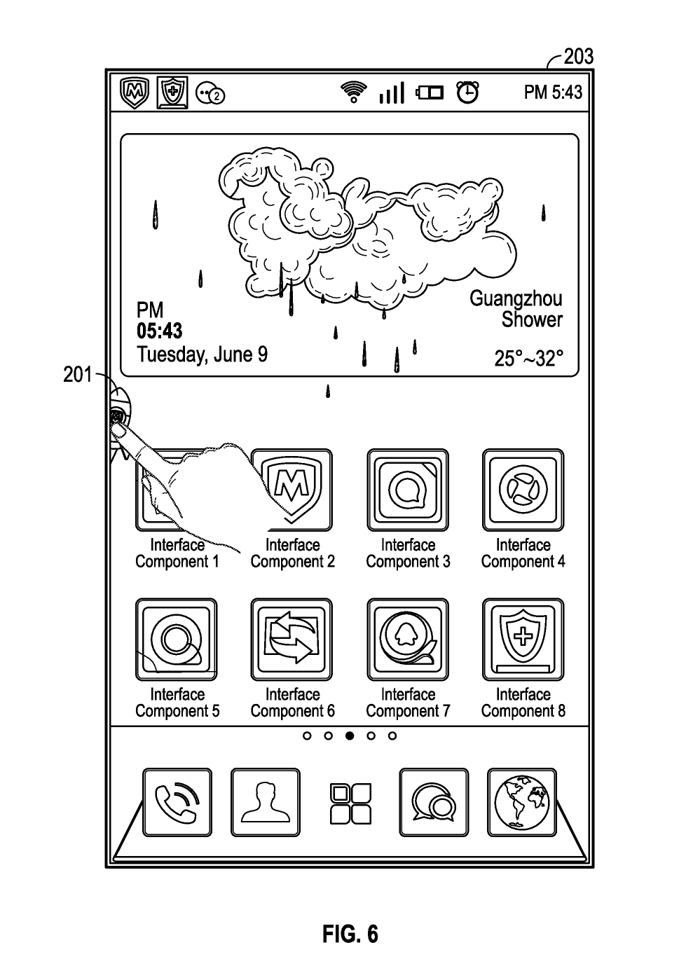

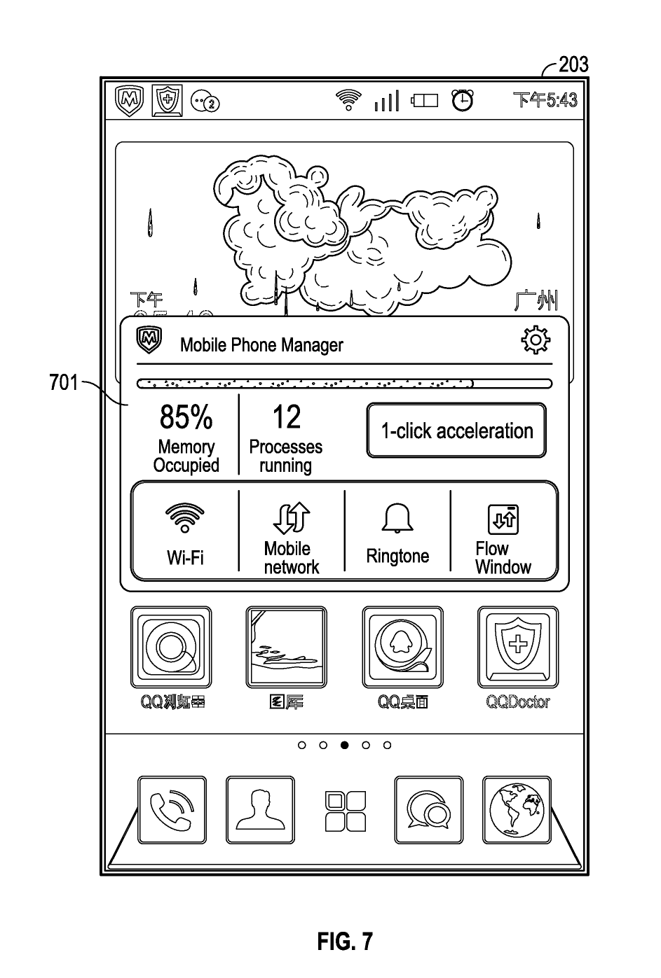

In addition, as illustrated in FIG. 6, the user can also click on the rocket-form floating window 201 to obtain a clicking operation on the rocket-form floating window 201. An interface opening command can be generated in accordance with the clicking operation, through which a graphical interface 701 corresponding to the interface component can be opened, as illustrated in FIG. 7.

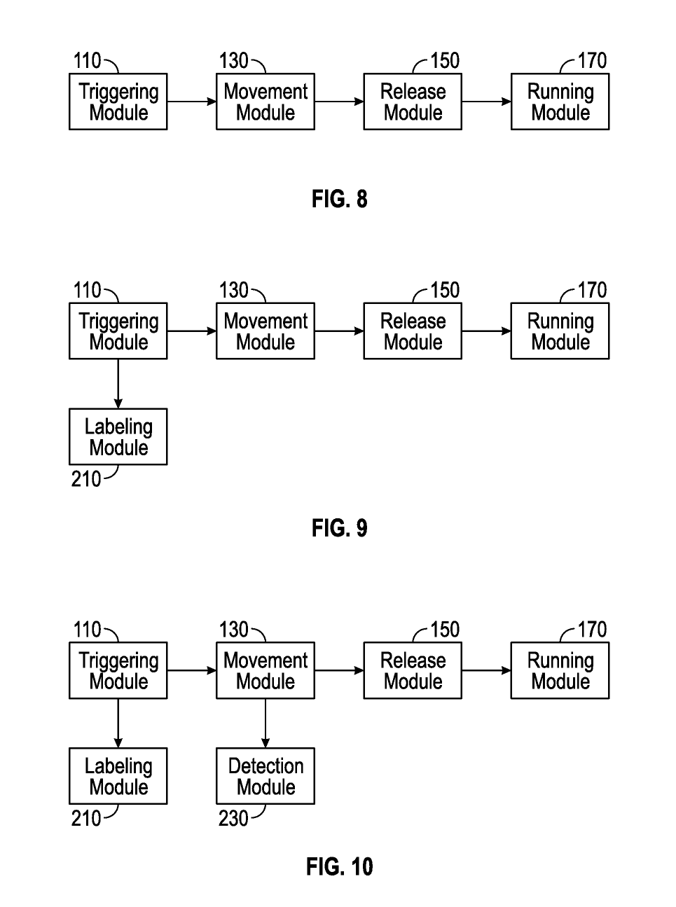

FIG. 8 is a schematic diagram illustrating an example of an arrangement of an interface component launching device according to various embodiments. The device can comprise: a triggering module 110, a movement module 130, a release module 150, and a running module 170.

The triggering module 110 triggers movement of a floating window corresponding to an interface component by operating on the floating window.

According to some embodiments, an interface component can be an application program, a functional module of an application program or a plugin in an application program. As used herein, a floating window refers to a window that displays the current status of an interface component. It is considered part of the interface component, and is placed in a graphical interface for users to view anytime. According to some embodiments, a graphical interface can be a desktop interface.

According to some embodiments, the triggering module 110 can generate a dragging command by obtaining a dragging operation entered on a floating window corresponding to an interface component. The floating window can be converted to a first form and moved in accordance with the dragging command. According to these embodiments, the dragging operation works on the floating window. According to some embodiments, the first form comprises a preset form. Through a dragging operation on a floating window, the trigger module 110 can trigger a continuous movement of the floating window in a graphical interface following a user's dragging operation, and convert the floating window into a first form during the movement. Examples of a first form of a floating window include, but are not limited to, a form of a rocket.

According to some embodiments, and as illustrated in FIG. 9, the interface component launching device can comprise a labeling module 210 that provides a label to a first region in accordance with the movement of the floating window. According to some embodiments, the first region comprises a preset region.

According to these embodiments, a first region can be configured in a graphical interface. When a floating window moves, the labeling module 210 can mark the first region configured in the graphical interface by providing a label to the first region. According to some embodiments, a process of providing a label to a first region by the labeling module 210 can be providing a color label to the first region. According to some other embodiments, a process of providing a label to a first region by the labeling module 210 can be highlighting the first region. According to yet some other embodiments, a process of providing a label to a first region by the labeling module can be providing a prompt message such as “drag the floating window here” in the first region. Methods of providing a label to a first region are well known to those skilled in the art.

The movement module 130 moves the floating window to a first region.

According to some embodiments, the movement module 130 can move a floating window to a first region by operating on the floating window.

According to some embodiments, and as illustrated in FIG. 10, the interface component launching device can comprise a detection module 230 that feeds back a release message to a floating window that has moved to a first region, and prompts a user to convert a drag operation into a release operation, thereby releasing the floating window.

According to some embodiments, a release message can be presented in the form of changing the color of the first region. According to some other embodiments, a release message can be presented by generating a vibration. According to yet some other embodiments, a release message can be presented by displaying such texts as “Please release” around the interface component icon. Methods of presenting a release message are well known to those skilled in the art.

According to some embodiments, the detection module 230 can check the first region to determine whether the floating window is located in the first region. If yes, then a release message can be generated and fed back; if not, then no action is taken.

According to some embodiments, the detection module 230 can generate a vibration command in accordance with the floating window that has moved to the first region, enabling a terminal device on which an interface component is installed to vibrate in accordance with the vibration command. According to these embodiments, a vibration command can be generated when a floating window moves to a first region, and a vibration of a terminal device on which the interface component is installed can be generated via the vibration command. According to some embodiments, a terminal device on which an interface component is installed can be a mobile terminal device. According to some other embodiments, a terminal device on which an interface component is installed can be a non-mobile terminal. By generating a vibration of the terminal device via a vibration command when a floating window of an interface component enters a first region on the terminal device, the process of running the interface component can be visually fed back to a user. This brings the interface component and the user closer and enhances the interface component's ease of use.

The release module 150 triggers a release command to release the floating window in the first region.

According to some embodiments, the release module 150 can detect a user's release operation on a floating window that has moved to a first region, and generate a corresponding release command in accordance with the release operation on the floating window.

According to some embodiments, the release module 150 can play an animation showing the step of releasing the floating window. According to some embodiments, when a user triggers an operation to release a floating window, the release module 150 can play an animation showing a sudden release of the floating window following the user's release operation, thereby vividly reflecting the running of the interface component. By way of example only, if the floating window is a rocket-form floating window, the rocket-form floating window can move after a dragging operation entered by a user. When the user triggers a release operation, the rocket-form floating window can be released, i.e., the release module 150 can play an animation showing the launch and acceleration of the rocket-form floating window in a graphical interface.

The running module 170 runs the interface component corresponding to the floating window in accordance with the release command.

According to some embodiments, after obtaining the command to release a floating window, the running module 170 can run the interface component corresponding to the floating window. According to some embodiments, the interface component can be an application program that releases the memory. According to these embodiments, the running module 170 can trigger the running of the interface component in accordance with the release command, and release the memory via the running interface component. According to some specific embodiments, the running module 170 can run an application program that releases the memory when a command to release a floating window is triggered. The application program can inspect programs that are running in the operating system and close some unnecessary programs to release the memory and to accelerate the running of the operating system.

According to some embodiments, the running module 170 can obtain and display a result of the running of an interface component when the running of the interface component is complete.

According to some embodiments, the running module 170 can obtain a result of the running of an interface component and display the result in a graphical interface. According to the embodiments where the interface component is an application program that releases the memory, a result of the running of the interface component after the running is complete can be the size of the memory released.

According to some embodiments, the running module 170 can obtain a clicking operation in the floating window, generate an interface opening command in accordance with the clicking operation, and open a graphical interface of the interface component corresponding to the floating window via the interface opening command. According to these embodiments, a user can open a graphical interface corresponding to an interface component by a clicking operation on the floating window of the interface component. This one-click operation greatly simplifies user operations.

The above-described interface component launching device can run in such apparatuses as mobile terminals.

According to the above-described interface component launching method and device, in a process of triggering movement of an interface component icon by an operation on a floating window, generation of a release command to release the floating window can be triggered when the floating window moves to a first region, enabling the interface component to run via the release command. In this process, a user can accomplish the running of an interface component by merely two consecutive operations, namely, triggering the movement of the floating window and triggering the release of the floating window. No complicated operation is necessary. This greatly enhances the convenience and interactivity.

Even though some embodiments have been described as involving moving a floating window to a first region, followed by feeding back a release message to the floating window that has moved to the first region, the present disclosure does not require a specific first region. Any movement of the floating window that has met one or more pre-defined criteria, the meeting of which is detectable by a device on which the relevant interface component is installed, can be used to trigger the feeding back of a release message to the floating window that has moved in a way that has met the one or more criteria. Examples of such criteria include, but are not limited to, a certain distance by which the floating window has moved, the floating window's speed of movement, or a certain trail of the floating window's movement. For example, a release message can be fed back to the floating window when and only when the floating window has moved more than 2 inches away from its original location, regardless of the direction of its movement. Another example: a release message can be fed back to the floating window when and only when the floating window has moved at a speed higher than 2 inches a second across the touch screen. Yet another example, a release message can be fed back to the floating window when and only when the trail of the floating window's movement is an “S” shape. One or more of such criteria can be used in combination to define the threshold for triggering the feeding back of the release message to the floating window.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. An interface component launching method comprising:
triggering movement of a floating window corresponding to an interface component by operating on the floating window,
moving the floating window to a first region,
triggering a release command to release the floating window in the first region, and
running the interface component corresponding to the floating window in accordance with the release command.

2. The method of claim 1, wherein triggering movement of the floating window comprises:
generating a dragging command by obtaining a dragging operation entered on the floating window corresponding to the interface component,
converting the floating window into a first form in accordance with the dragging command, and
moving the floating window.

3. The method of claim 1, comprising:
providing a label to the first region in accordance with the movement of the floating window.

4. The method of claim 1, comprising:
feeding back a release message to the floating window that has moved to the first region.

5. The method of claim 4, wherein feeding back a release message to the floating window that has moved to the first region comprises:
checking the first region to determine whether the floating window is located in the first region, and
generating and feeding back the release message if and only if the floating window is located in the first region.

6. The method of claim 5, wherein generating and feeding back the release message comprises:
generating a vibration command in accordance with the floating window that has moved to the first region, enabling a terminal device on which the interface component is installed to vibrate in accordance with the vibration command.

7. The method of claim 1, comprising:
releasing the floating window via the release command, and
playing an animation showing the releasing of the floating window.

8. The method of claim 1, wherein the interface component comprises an application program that releases memory, and running the interface component comprises:
triggering the running of the interface component in accordance with the release command, and
releasing the memory via the running interface component.

9. The method of claim 1, comprising:
obtaining and displaying a result of the running of the interface component when the running of the interface component is complete.

10. The method of claim 1, wherein the interface component comprises at least one of an application program, a functional module of an application program, and a plugin in an application program.

11. An interface component launching device comprising:
a triggering module that triggers movement of a floating window corresponding to an interface component by operating on the floating window,
a movement module that moves the floating window to a first region,
a release module that triggers a release command to release the floating window in the first region, and
a running module that runs the interface component corresponding to the floating window in accordance with the release command.

12. The device of claim 11, wherein
the triggering module generates a dragging command by obtaining a dragging operation entered on the floating window corresponding to the interface component, converts the floating window to a first form in accordance with the dragging command, and moves the floating window.

13. The device of claim 11, comprising:
a labeling module that provides a label to the first region in accordance with the movement of the floating window.

14. The device of claim 11, comprising:
a detection module that feeds back a release message to the floating window that has moved to the first region.

15. The device of claim 14, wherein
the detection module checks the first region to determine whether the floating window is located in the first region, and generates and feeds back the release message if and only if the floating window is located in the first region.

16. The device of claim 14, wherein the detection module generates a vibration command in accordance with the floating window that has moved to the first region, enabling a terminal device on which the interface component is installed to vibrate in accordance with the vibration command.

17. The device of claim 11, wherein
the release module releases the floating window in accordance with the release command, and plays an animation showing the releasing of the floating window.

18. The device of claim 11, wherein the interface component comprises an application program that releases memory, and the running module triggers the running of the interface component in accordance with the release command and releases the memory via the running interface component.

19. The device of claim 11, wherein
the running module obtains and displays a result of the running of the interface component when the running of the interface component is complete.

20. The device of claim 11, wherein the interface component comprises at least one of an application program, a functional module of an application program, and a plugin in an application program.
